(19) United States
(12) Patent Application Publication
(10) Pub. No.: US 2009/0243140 A1
(43) Pub. Date: Oct. 1, 2009

(54) ART INFUSED FILMS AND METHODS FOR MAKING THE SAME

(76) Inventor: Barry Levenson, Sherman Oaks, CA (US)

Correspondence Address: PERKINS COIE LLP, POST OFFICE BOX 1208, SEATTLE, WA, 98111-1208, US

(21) Appl. No.: 12/363,614

(22) Filed: Jan. 30, 2009

Related U.S. Application Data
(60) Provisional application No. 61/025,741, filed on Feb. 1, 2008.

(51) Int. Cl. B29C 47/08

(52) U.S. Cl. 264/166

(57) ABSTRACT

In certain embodiments, a process for producing clear plastic films comprises creating a high resolution digital art file having a rendering of an image, wherein the image has one or more fill areas and one or more borders composed of a series of vector lines, lines, dots, or marks representing cutting paths of various depths or heights. The image from the art file is assigned depths or heights and converted into a relief file, and subsequently engraved into a die such that the die has one or more engraved paths creating a topography mirroring that of the image in the art file or relief file. A film is then extruded with the image from the die being infused into the film as it is extruded. The resulting film includes one or more engraved paths or lines making up the image, the paths or lines having a maximum depths or heights equal to, and/or greater than one third of the thickness of the film.

### CROSS-REFERENCE TO RELATED APPLICATIONS

This application claims the benefit of U.S. Provisional Patent Application Ser. No. 61/025,741, filed Feb. 1, 2008, which is incorporated herein by reference.

### BACKGROUND

Existing methods for creating a design on a clear film, such as engraving, imprinting, or embossing, are both time consuming and costly. These methods require first forming a piece of film and then a separate image transfer step to engrave, imprint or emboss a design on the film. For example, after a film is formed, in a separate step, an image is typically transferred onto the film by a hot stamp impression or a press method embossment. Embossing an image onto a thin and clear film requires a press whereby a heavy and thick metal die is placed onto the press, and each film sheet being pressed by the press to impart or emboss the image thereon. Existing methods produce films with shallow depths or heights of the three dimensional images created on a film, particularly in thin films.

Methods for transferring images or artwork to a die to be used in the engraving, imprinting, or embossing techniques typically require each image or artwork to be copied and pasted onto a die. Such multiple copy-paste steps create a “quilt” look with unwanted lines and seams in the final design on the die and in the final film product resulting in undesirable quality, appearance and resolution of the design on the film product.

Thus there is a need to improve forming or imprinting images into films having high resolution at a low cost.

### SUMMARY

In one embodiment, a process for producing clear plastic films comprises creating a high resolution art file (e.g., high resolution digital art file) having a rendering of a design (e.g., image, design, text, or other art form), wherein the design has one or more fill areas and one or more borders composed of a series of lines, vector lines, dots, or marks of various lengths and widths representing engraved paths or elevated lines. The art file may be optionally converted into a relief file where heights, depths, and/or weights are assigned to the vector lines, lines, dots, or other marks which make up the image, creating a three-dimensional (3-D) rendering of the image. Optionally, heights, depths and/or weights may be assigned to the image in the high resolution digital art file. In another embodiment, the heights or depths assigned may be less than, equal to or greater than half the thickness of the film in which the image will be infused.

The image from the relief file is subsequently engraved, cut, or otherwise transferred onto a die such that the die has one or more engraved paths or raised lines making up an image having a topography that mirrors or represents the image in the art file and/or relief file. A film is extruded on the die thus infusing the image from the die into the film as it is being extruded, wherein one or more engraved paths or raised lines making up the image in the film will have varying depths or heights. For example, a film can be created with a high resolution image (the high resolution image from the art and relief files) having depths and/or heights less than, equal to, and/or greater than half the thickness of the film. In certain embodiments, the depths or heights may be equal to and/or greater than half the thickness of the film.

In certain embodiments, palette designs made up of a series of vector lines, lines, dots, or marks with desired depths, heights and/or angles may be used to create an image in a high resolution art file or a three dimensional relief file. This image composed of palette designs is transferred to a die and is subsequently extruded or infused into a film.

In certain embodiments, the die is made of silicone, rubber, or other polymer material and may be on a cylindrical roller. The die may also be laser engraved with an image from a relief file or high resolution digital art file. During the extrusion process, plastic film in a liquid state passes through and/or over the engraved die. The film may then be pressed against a chill roller which cools and solidifies the film with the image from the die into a rigid state. The image is transferred with a high resolution from an art file to a relief file to the engraved rubber die and then to the film. Indeed, this process of extrusion may infuse or transfer a perfect mirror image of the image from the die or replicate the image from the die into the resulting film as the film is being created, and this process is capable of capturing the fine details of high resolution digital art and imparting these fine details, depths and heights into a thin film.

### BRIEF DESCRIPTION OF THE FIGURES

FIG. 1 is a flow diagram showing an example of a film extrusion process according to an embodiment of the present invention.

FIG. 2 shows examples of tone density palettes having various arrangements of, vector lines, lines and/or dots according to an embodiment of the present invention.

FIG. 3 shows examples of tone density palettes having various designs according to an embodiment of the present invention.

### DETAILED DESCRIPTION

The following description is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

One aspect of the invention relates to a process for producing a film with a desired design (designed film) comprising the following steps: creating a digital art file (“art file”) having a rendering of a design; converting the art file into a relief file which maintains the resolution from the art file; engraving a die having the design from the relief file; and extruding a film material through and/or over the engraved die to form the designed film.

### Creating an Art File and a Relief File.

In certain embodiments, an art file and/or a relief file includes vector art and/or bitmap art. In certain embodiments, the art file and/or relief file has a resolution of 2000 dpi or higher. In certain embodiments, the resolution may be from 400 to 2000 dpi, 1200 to 2000 dpi or 1000 to 1200 dpi.

In certain embodiments, an art file and/or a relief file having a rendering of a design comprises one or more fill areas and one or more borders. As used herein, the term “border” means a series of vector lines, lines, dots, or marks representing cutting paths or elevated lines; the term “fill area” means the area that is outlined or surrounded by borders; the term “design” means the image with specific topography and/or visual effects on the final designed film.

In certain embodiments, characteristics may be assigned to the fill areas and borders in an art file and/or a relief file to represent the desired topography and/or visual effects of the resulting designed film. As used herein, the term “characteristics” means depths, heights, width, angles, colors, densities, thickness and/or weights of a fill area or a border. Different fill areas and different borders may have different characteristics. Different parts of the same fill area or the same border may also have different characteristics.

In certain embodiments, the art file contains enough characteristics to create a die having the desired design.

In certain embodiments, the art file does not contain enough characteristics to create a die that can be used to extrude the desired designed film. The art file is then assigned with the desired characteristics to create a 2-D or 3-D relief file, which can be used to create the die. In certain embodiments, the relief file is further converted into a TIFF file which is used to create the die by any methods (e.g., laser engravement, cutting methods) to engrave the desired design that mirrors the design from the TIFF file.

In certain embodiments, a design may be modified into an art file (e.g., by using programs such as, Photoshop, Illustrator, etc.) and converted into a two dimensional or three dimensional relief file using programs such as, e.g., ArtCam, Maya, Rhino, other CAD software or other 3-D modeling programs known to those of skill in the art.

In certain embodiments, the converted design is fit into a selected layout area within the art file and relief file. The design image in the art file and relief file may be made up of one or more designs from an assortment of design palettes and/or vector lines, lines, dots, or other marks with varying characteristics.

### Topography of the Design

In certain embodiments, depths or heights of borders and fill areas in an art file or a relief file of a design are determined based on the desired application for the resulting designed film. For example, smaller line depths or heights may be preferred for designed films which will be used as glass laminations. For designed films used for tape applications, the line depths or heights may be greater in order to create more severely raised lines on the resulting film, which are more easily noticeable.

In certain embodiments, the depth or height assignments in specific areas are created to contrast the depths or height assignments in the adjoining areas to increase the three dimensional effect in the designed film. Therefore, the designed film will have a better 3-D quality if it has paths or lines with greater depths or heights. Preferably for thin films the paths or lines have depths or heights less than half the thickness of the film.

In other embodiments of the present invention, the paths or lines achieved in a designed film have depths or heights less than, equal to, and/or greater than half the thickness of the film. For example, depths or heights of from about 0.5 mil to 1.5 mil can be achieved in a 3 mil (1 mil=0.001 inch) film. In another example, depths or heights from about 0.5 to 10 mil can be achieved in a 15 mil film. Depths and heights that can be achieved in a film will increase as the film's gauge or film thickness increases.

In one embodiment, designs infused into a Polycarbonate film have depths or heights that are less than, equal to, and/or greater than half the thickness of the film. Table 1 shows example depth or height ranges for various film thickness.

TABLE 1
DEPTH or HEIGHT CHART

| Film Gauge or | example depth or |
|---|---|
| thickness (inches): | height ranges (inches) |
| 0.003 | 0.0005-0.0015 |
| 0.004 | 0.0005-0.002 |
| 0.005 | 0.0005-0.0025 |
| 0.006 | 0.0005-0.003 |
| 0.007 | 0.0005-0.0035 |
| 0.008 | 0.0005-0.004 |
| 0.009 | 0.0005-0.0045 |
| 0.010 | 0.0005-0.005 |
| 0.011 | 0.0005-0.0055 |
| 0.012 | 0.0005-0.006 |
| 0.015 | 0.0005-0.01 |

Height and depth can vary depending on the film thickness and the film material. The ratio of the maximum depth/height to total film thickness is preferably at least about 0.03:1, at least about 0.05:1, at least about 0.8:1, at least about 0.1:1, or at least about 0.2:1, at least about 0.3:1, at least about 0.4:1, or at least about 0.5:1.

The borders of a design may also be modified using a 3-D block modeling system (e.g., in color or black and white) in creating a relief file. A desired width, height, and/or depth for a border may be assigned. The depth or height used for the borders of the design is determined based on the outline border depth or height and the color density. Black, thick, or wide lines may be used for any border to create a deeper three dimensional border which accentuates the 3-D effect of the image in a relief file and the resulting infused film.

In certain embodiments, the borders in a high resolution digital art file are made from vector lines or a series of dots forming lines. A border is normally dark and thick in density and/or wide. This feature allows for deeper depth assignments, which enables a laser or other cutting device to engrave deeper into the rubber or other die material along the border. In certain embodiments, depths or heights are assigned to the border, which are deeper or greater than the depths or heights assigned to the inside or fill area of an art image. The deeper depths or greater heights allow the laser to cut a wide swath/path. In certain embodiments, the thicker, wider or denser a vector line or other line is, the hotter a laser will run and the deeper the engraved cutting path in a die will be. More sever angles can also be engraved. The resulting depths, heights, and angles are then reflected in the resulting film.

In certain embodiments, white or a depth or height value of “0” is assigned to a fill area in the art file to create a clear area on a designed film.

In certain embodiments, angles ranging from about 22 to 45 degree or greater may be assigned to the fill areas and/or the borders in an art file. In certain embodiments, angles up to 120 degree may be assigned to provide more severe contrast in the design on the designed film.

### Visual Effects of the Design

Various combinations of the characteristics assigned to the fill areas and the borders in an art file or a relief file will create various topographies and/or visual effects on the designed film. Examples of visual effects include, without limitation, frosted effects, glass effects, shadow effects, 3-D effects, swirling effects, wave effects, contrasting effects, shaded effects, flowing effects, morphing effects, mortar effects, distorted glass effects and other 2-D or 3-D effects.

In certain embodiments, contrasting vector lines, lines or dots with higher densities in an art file or a relief file may create enhanced three dimensional effects on the designed film. In certain embodiments, the borders are assigned greater depths or heights than the inside or fill area. Thicker lines with a heavier density and greater depths or heights create deep craters or valleys with corresponding pillars or peaks for enhanced 3-D effects and contrast in the films. More sever angles can also enhance the 3-D effects in the films.

A fill area may be outlined with a clear border to create or enhance a 3-D effect. A designed fill area may be outlined with a thicker line or line of different depth, where the space between the fill area and the line is clear. This creates a contrast that enhances the three dimensionality of the image.

Frosted effects can be created by placing very fine halftone information or dots and lines or vector lines in a close tight configuration with light density of the dots and lines. High resolution art images may be frosted by assigning varying heights and depths and leaving detailed areas blank, clear, or void to highlight and contrast the varying depths and heights in fine detail.

In certain embodiments, an art file or a relief file is created to produce designed films with a glass like appearance (glass effect). Such glass-like films can be used to decorate glass blocks, distorted pieces of cast glass, windows, shower doors or other forms of glass. Resulting films may have varying thickness, for example, a thickness ranging from about 1 mil to 50 mil gauge or about 3 mil to 30 mil gauge (1 mil=0.001 inch). In certain embodiments, vertical or horizontal images may be applied to cover an entire film sheet depending on the die and film sleeve size selected for a particular film extrusion. Examples of sizes of images for use in glass effect films or other films or examples of sizes of films may be as follows: Sheet sizing (dimensions in inches): 24×36, 50×42, 60×60, 20×40, 25×40, or 25×20.

In certain embodiments, vector lines or fine lines with light densities are distorted to create designs that have a flowing or morphing effect in an art file or a relief file. Shadows may also be created in the designs to help accentuating the natural shadows found in glass when light hits. In certain embodiments, these vector lines or fine lines with light densities are composed of pixels that are closely grouped or have high dots per inch (DPI).

In certain embodiments, visual contrasts are used to create the glass effects in an art file or a relief file. The desired visual contrasts are created by using design palettes to fill in one or more fill areas or to make up a central image in a design from an art file and/or a relief file. Multiple design palettes may be used together or separately to create the desired design with desired contrasts.

In certain embodiments, an art file and/or a relief file with simulated glass or glass block images is created. These images may be created using tight fine lines in perfect alignment. Fine lines with very light densities can be used in the images to create a swirling effect (e.g., through 3-D morphing programs that feather, tile, and distort images or through the use of other CAD software) and make glass and glass block images resemble cast, etched or engraved glass. This effect may be achieved by applying a wand morphing tool or software to lines that are very thin and closely grouped together, wherein a 3-D relief file with a flowing cast glass image or distorted appearance is created. Optionally, the tiling and feathering software may be used to eliminate unwanted lines, pattern breaks and ends of the patterns or seams in an image to achieve a seamless and uniform design. Other glass like effects such as a molded or rippled 3-D appearance may be created by varying the depths or heights in an art file and/or a relief file.

Borders that resemble mortar may be created around the glass blocks or images. A mortar appearance may be achieved by using vector lines, lines, dots, marks, thicker lines with heavy density or design palettes to create a rough texture or frosted view around the border of the image. Halftone colors, e.g., grey or black, may also be used for the mortar effect. The inside of the glass or glass block image may be created by using a dot structure of white and grey dots, with some mid-tone grey dots to simulate shadows and contrasts. Varying dot densities, depths or heights for the vector lines, lines, dots or dot groups are also used. Glass block images may also have greater depths or heights around the edges of the image to create a 3-D effect. The simulated glass or glass blocks may be available in various dimensions, e.g., round, rectangular, square, or other geometric shapes. As an example, glass blocks may be in the form of about 4″ inch squares to 12″ inch squares, or any other desirable dimension depending on the application and use of the glass blocks.

The glass effect, simulated glass or glass block films may be applied or used in various ways. For example, a glass effect film may be inserted or laminated between two sheets of glass. This method is useful for creating a safety glass. The glass effect films may have an adhesive on one side to be applied to glass (window film) or other substrates in a permanent or temporary manner. Optionally, suction cups may be used for a glass effect film such that it can be reapplied and reused multiple times.

### Design Palettes

In certain embodiments, an art file and/or a relief file can be created using one or more design palettes. A design palette is an art file or a relief file that renders a specific design which comprises one or more topographic designs and/or one or more visual effect. A design palette includes one or multiple fill areas, borders and/or other notations which represent contrast cutting paths. The fill areas, borders and/or other notations are assigned various characteristics to achieve the desired topography and/or visual effects on a die or other substrates. Different fill areas and different borders may have different characteristics. Different parts of the same fill area or the same border may also have different characteristics.

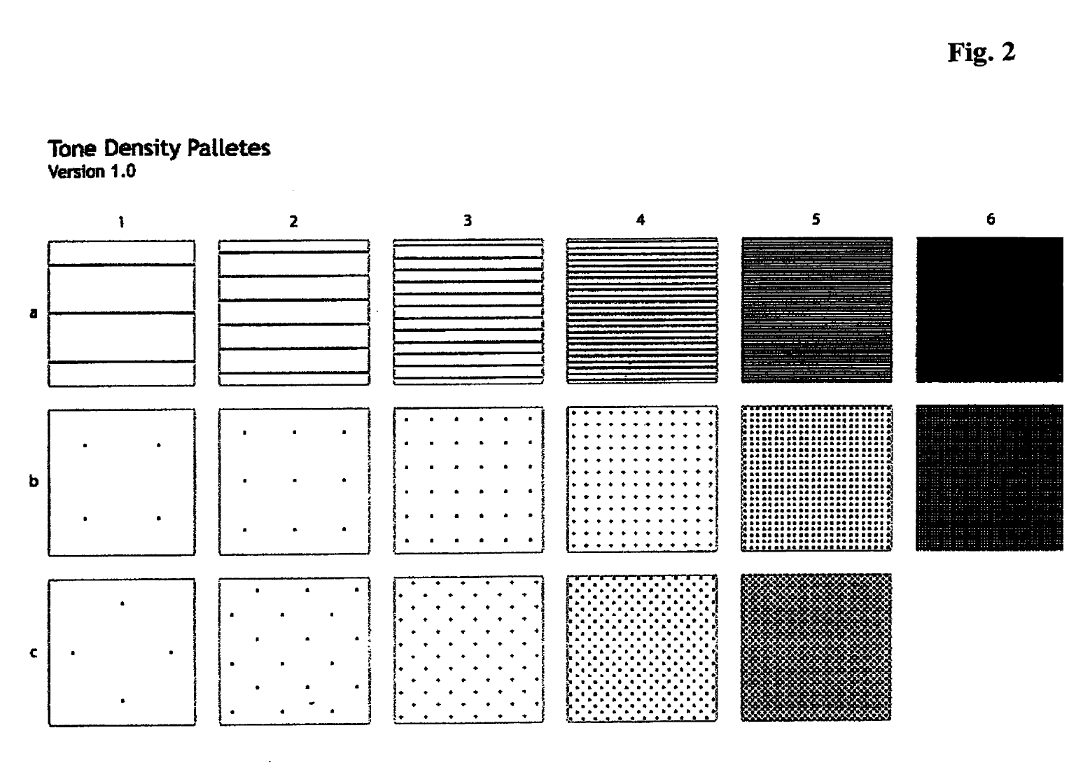

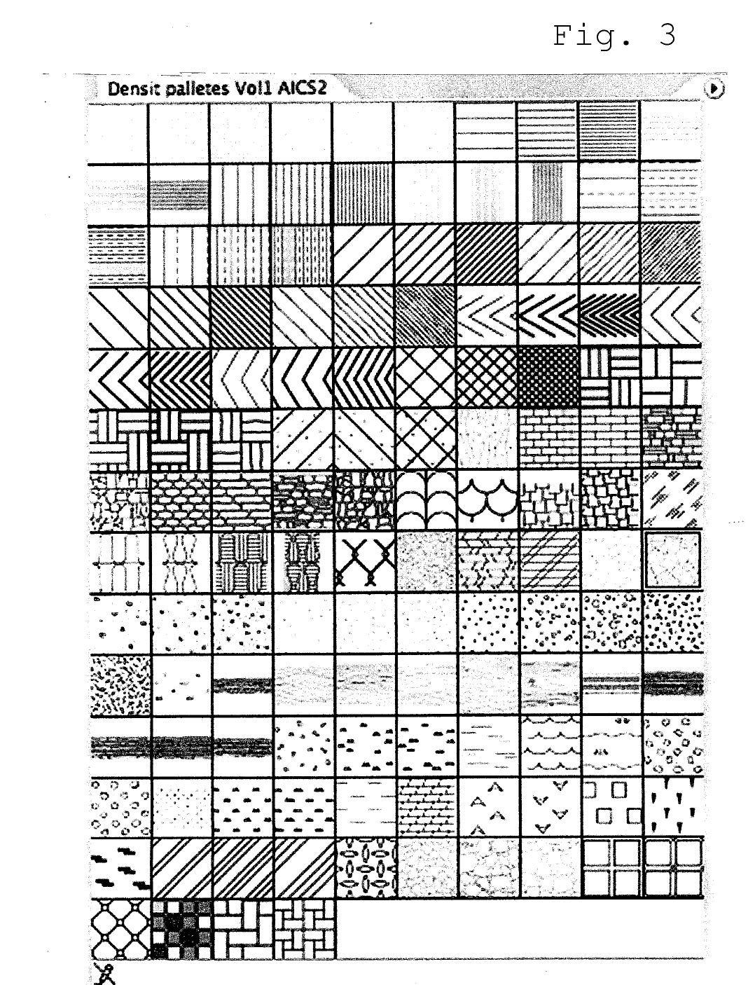

Any design or visual effect can be made into a design palette. Examples of design palettes include, without limitation, frosted effect palettes, glass effect palettes, shadow effect palettes, 3-D effect palettes, swirling effect pallets, wave effect pallets, contrasting effect pallets, shaded effect pallets, flowing effect pallets, morphing effect pallets and mortar effect pallets. Examples of such palettes are shown in FIGS. 2 and 3.

Design palettes can be used to fill in the detail of a design in an art file and/or a relief file to create, augment, enhance or supplement the design. The various design palettes can be used within the design or surrounding the design, to create borders, or to make up the design in part or in its entirety (e.g. cast glass designs).

Design palettes may be used inside or outside of the three dimensional lines or borders outlining part or all of the design in an art file and/or a relief file. The design palettes may be arranged in a series of glass blocks covering an entire film or sheet having a desirable size, e.g., a sheet having dimensions of 24″×36″ or 28″×40″.

A 3-D modeling program may be used to distort and allow for 3-D blocking of an art file design to create spaces in the design for placing palette designs and/or vector lines to create visual effects (e.g. contrasting) in the design if desired. This procedure further enhances the visual appearance of the design in the resulting designed film.

The design palettes may be used on or with borders with various characteristics to fill a fill area, e.g., using the darkest color black at 100%. Filling the fill areas with certain design palettes can also accentuate contrasts in the design on a clear film.

A fill area may be dissected into smaller areas or groups wherein multiple pallet designs or vector lines can be applied within smaller outlined areas to create a visual contrast enabling a viewer to identify the image easily.

A design palette may be configured or arranged within an art file and/or a relief file to capture the effects of light and shade to achieve a desired effect or appearance. Images may be taken from original or copied works and transformed into an art file and/or a relief file through the use of design palettes. For example, an art file and/or a relief file having an image of Santa Clause can be created wherein design palettes such as billowing swirls of lines, dots, and halftone grey's are used to outline Santa Clause's beard, eyebrows, and the fur around his collar to create visual contrasts within the Santa Clause image. Any blank areas, or areas not occupied by palette designs in the high resolution digital art file may be optionally filled in with other designs or left blank. For example, the blank areas may be made to appear frosted which further enhances the three dimensional appearance of an image in the relief file and once it is infused into a film.

In certain embodiments, an art file and/or a relief file is created by creating a design by selecting one or more art to be printed or imprinted on a designed film and one or more art concepts for the art file; estimating the size and the spatial requirements of the design; creating the layout of the design; and converting the design into a digital art file and/or a relief file.

The art selected to be printed or imprinted on a designed film can be a vector art or bitmap art. Examples include, without limitation, an original designed art image (e.g. freehand art, scanned art, pictures, photos, or digitally generated images or designs), text (e.g. “Thank You”), logo, texture, design palette or any other type of topographical design. The art may optionally be selected from stock art images.

An art concept for the art file can be any topographical and/or visual effect desired to achieve on a designed film. Examples include, without limitation, frosted effects, glass effects, shadow effects, 3-D effects, swirling effects, wave effects, contrasting effects, shaded effects, flowing effects, morphing effects, mortar effects, distorted glass effects and other 2-D or 3-D effects.

2. Creating a Die

The design from an art file and/or a relief file is engraved into a die (e.g., a rubber or silicone die) such that the resulting die has one or more engraved paths which create a topography mirroring that of the design from the relief file.

Examples of materials used to create a die may include, e.g., composite rubber, Urethane resin, polycarbonates, PVC, acrylics-(PMMA), polypropylenes, polyethylenes, PLAs, Co-Polys, various polymers, or other plastic materials. Preferably, a rubber die includes a silicone additive or silicone release properties to facilitate the quick and smooth release of film or other materials from a die cylinder. Because of such properties, the die cylinder can seamlessly transfer the die image or text to a film during the extrusion process without copy or paste lines being visible.

Dies can have varying sizes and thickness. The die is in the form of a cylindrical roller. The dies can be adhered to a backing, e.g., a metal backing, or can be in the form of a rubber sleeve which is placed onto a metal cylinder. Such a cylinder may be used in conjunction with a generally adjacent chill or cooling roller in the extrusion step. Liquid film materials pass between the rubber sleeve cylinder and the chill cylinder to create a finished film with a detailed high resolution 3-D image showing the assigned depths and heights transferred from the die and infused into the film.

In certain embodiments, the die is created by applying a liquid coating of silicone, rubber, or other polymer coating that allows for high resolution image transfer or engraving on to a cylinder, wherein the cylinder may be made of metal or other rigid materials. The coating can be brushed or sprayed onto the cylinder and hardens after it is dried to create a cylindrical die. The cylindrical die can then be cut or engraved with the desired design from the relief file.

In certain embodiments, the coating can be used to create a flat die which is cut or engraved and then the subsequently wrapped around a cylinder and adhered in place.

In certain embodiments, the flat die can be wrapped around a cylinder and adhered in place and then cur or engraved to form the die with the desired design from the relief file.

In certain embodiments, the die is laser engraved. In certain embodiments, the die is engraved by acid-etching.

In certain embodiments, the die is engraved using a computer numerical control (CNC) milling machine.

In certain embodiments, an art file or a relief file may be sent electronically or uploaded to a laser die supplier. Images from the art file represented in a relief file are then laser engraved onto a cylindrical die or a flat die.

In certain embodiments, upon receiving the information from the art file or relief file, the laser can engrave a path replicating the depth or height and angles of each vector line, line, mark, and/or dot from the art file and relief file into a die. Dies may be engraved by a laser which exactly replicates and engraves the design paths from the relief file including heights, depths, and angles. All edges, frosted appearances, and marks contained in the high resolution digital art file are seamlessly transferred from the art file to directly or via a relief file to the die. The depths or heights assigned to certain vector lines, lines, marks, or dots in the art file may be replicated and engraved into the die. For example, in one embodiment, a 3-D image having depths or heights less than, equal to, and/or greater than half the thickness of the film product can be created wherein the depths or heights are assigned to the image of a high resolution digital art file converting it to a relief file, and then the image from the relief file is engraved into a die.

In certain embodiments, a rubber die may be laser engraved with the image from the high resolution digital art file creating a topography on the die which mirrors that of the image from the art file. In other embodiments, the rubber die may be engraved with an image that is an exact replica of the image from the high resolution digital art file such as high resolution master files.

In certain embodiments, the 3-D image of a relief file is engraved in a die using a FOBA laser.

In certain embodiments, during the engraving process of a die, scratching or roughing of the sides or walls of the engraved paths or valleys in the die can be performed. As a result, the extruded film will have a frosted appearance which is created by the scratched or roughed texture on the die. In another embodiment, a lalique like sculpted effect may be created on the die by roughing or scratching the walls of the engraved paths or valleys. The lalique effect would be transferred to a film during the extrusion process.

Extrusion

In certain embodiments, an engraved cylindrical sleeve is sent to a film extruder where it is placed onto an extruder and film substrates are run through the extruder. A film is then extruded with the image from the die, wherein the film includes one or more engraved paths having the characteristics as assigned in the art file and/or relief file. During the extrusion process, film material can be in a liquid state and will pass through and/or over the engraved die. In certain embodiments, the extruded film is pressed against a chill or cold roller which cools and solidifies the film into a rigid state, thereby securing or preserving the image transferred from the engraved die and infused into the film. Indeed, the image and topography created from the art file and relief file are completely transferred and replicated in high resolution from the engraved die to the film. The image transfer or infusion is part of the extrusion process. Because an image is transferred and infused during the actual extrusion process, the image is part of the film or film sheet. In certain embodiments, the image from the die can be impressed into the film during the extrusion process.

In certain embodiments, about 500 pounds of extruded material are run through the extruder per hour. When a run is completed and an image has been infused into the extruded film, the roll of film is trimmed down to a desired size (width or length) and additional processes may optionally be performed on the extruded film, such as, e.g., static charging, adhesive lamination, die cutting, etc.

Examples of film materials includes, but are not limited to, Polycarbonates, Polypropylene, Polyethylene, PET-G; R-PET, A-PET, Co-Poly blends, Acrylic, PVC, and other plastic, adhesive, or extrudable materials known in the art.

Extrusion of the film can create a film having at least one smooth side opposite the designed textured image side. The image is transferred or infused into the film or sheet as it is being manufactured during the extrusion process. As state above, the film material (in a liquid state) will pass over the engraved image of the die making the image integral or part of the film. This construction also allows the film to maintain its tensile strength.

In operation, the release quality, e.g., silicon additive or composition of a rubber, silicone, or other polymer die, allows for plastic resins in a liquid state to flow over and fill in the topography of the die. The liquid output is usually through an extrusion screw which helps determine the width and thickness of the liquid as it travels through and around a cylinder with an engraved sleeve or die. Optionally, a film resin may be in pellet form where during the extrusion process the pellets are transformed into a liquid.

In certain embodiments, clear effects in and on the film may be achieved by polishing the areas to create a clear effect with consistent depth variation either around the image or in selected areas.

In certain embodiments, certain areas may be left unpolished to create frosted appearances in the film. High resolution art images may be frosted by assigning varying heights and depths and leaving detailed areas blank, clear, or void to highlight and contrast the varying depths and heights in fine detail.

In certain embodiments, color additives can be added to the resins to give a colored or tinted effect to the finished infused films. One color per image may be used in certain embodiments.

In certain embodiments, as the die cylinder rotates it presses against a chill cylinder which accelerates the cooling process of the liquid film and the images on the engraved die are transferred or infuse into the film. The film is cooled immediately maintaining the topography of the die on the now solid film with the desired depths or heights and angles as described herein. As the liquid plastic resin is chilled, it is able to easily release from the die in a thickened solid state with the help of the release quality (silicon additive or composition) of the die. In certain embodiments, plastic film depths or heights may range from about 3 mil to about 30 mil depending on the application and film thickness. In certain embodiments, plastic sheet or film thickness may range from about 1/64 inch to about ¼ inch or greater. The process described herein can be used to create e.g., plastic films or sheeted plastic. The various depths or heights in the designs transferred into films during the extrusion process will match the depths or heights engraved in the rubber dies, which correlate to the depths or heights represented in the high resolution digital art file and/or relief file as described above. The depths or heights may be deeper or higher as the thickness of the film is increased or less deep as the thickness of the film decreases. The depths or heights in a film image may be less than, equal to, and/or greater than half the thickness of the film in which the image will be infused.

In certain embodiments, the image may be positive on the die such that it has exactly the same configuration or orientation as the image in the high resolution digital art file or relief file. For example, black lines from the images in an art or relief files are transferred as black lines onto the die. Also, spaces between the black lines or white lines from the art or relief files are interpreted by a laser or other cutting device and engraved into the die as line paths or white valleys. In these embodiments, the image in the film would be negative compared to the image in the die. Indeed, the image reverses itself when it is transferred or infused from the die (positive) to the film (negative) during the extrusion process. The image in the film can be a mirror image of the image in the die. The film, in a liquid state, passes over and through every ridge, nook, and cranny of the engraved die and creates deep cuts, undercuts, ridges, lines, etc. For example, during extrusion the liquid plastic material is extruded and run on the dies and the black lines in the die create the deep valleys in the film and the white lines or valleys in the die create the black lines or ridges in the film.

Optionally, a 3-D image may be reversed so it reads as a positive or negative image. Upon completion of the art-image in 3-D, with borders, line weights and line/dot depths or heights assigned, the image may be inverted and reversed out. The image may be converted into line depths or heights using ArtCam, or a similar three dimensional relief rendering program and a three dimensional relief art image is created with dots, lines, vector lines, halftones, or anything from the original art or high resolution art file. A negative image or a positive image can be run depending on the application (e.g. for outside use where the image is a 3-D image facing out, a positive image may be used). Conversely, for the inside of a window an image facing inward may be preferred. For a general glass lamination, either option is available.

### Applications

In accordance with the processes described above, desired images or text may be incorporated into everyday products and uses such as clear or frosted adhesive tapes. In certain embodiments, shipping tapes infused with the shippers' LOGO and “THANK YOU!” are created to turn the mundane task of sealing a shipping box into an opportunity to say “Thank You” for your business. The tapes can have various dimensions. In one embodiment, the tape is 2 inch wide and 3 mil thick. In one embodiment, the tape is an acrylic clear tape infused with the shippers' LOGO and “THANK YOU!”

In accordance with the processes described above, desired images or text may be incorporated into packaging such as clear plastic packaging, shrink wrap, boxes. In certain embodiments, desired designs are infused into a film which is then further processed into the outer shell of a package. Because the designed film cannot be readily duplicated, such packaging may afford security and authenticity at lower cost for the contents within the package, which is well needed in the music, movie and gaming industries. In certain embodiments, the package can be formed from the designed film by vacuum forming, die cutting and/or folding.

In accordance with the processes described above, desired images or text may be incorporated into glass or plastic laminates. Such laminates may be used in the housing and commercial building business, automotive and boat building business, for sporting goods, etc.

In accordance with the processes described above, desired images or text may be used to create “Window Art” or “Clear Window Art” by the methods disclosed herein. Window art includes images or text incorporated on static cling film or any other adhesive film. A simple suction cup attachment can be used for re-using the special effects film. Lighting effects can also be used to highlight the film images by fiber optics or similar low energy lighting capabilities. Films may be made for the following exemplary uses. A clear film with an engraved logo can be made and then scored or folded to make a clear box or gift box. Film can be created for tinting windows in home or automobile applications. A film can be charged and stick to a nonporous surface through static electricity. Adhesives may be applied to various films designs having a liner for easy peel and stick applications which may be applied to doors, windows, shower doors or stalls. Tapes may be created with a security feature in the form of deeply engraved lines and designs in the film. Tape security features can be enhanced through a combination of high resolution digital art infused images fitting on top (in concert with the printed image underneath) of another printed sub strait positioned under the film, which can be of any gauge). Shrink wrap plastics may be created where the images are not create to scale but upon shrinkage of the plastic wrap, the image than returns to scale and has high resolution deep depths or extreme heights in the infused film.

In certain embodiments, plastic sheetings infused with desired design are created using the process disclosed in the present invention. The plastic sheetings may be used as room dividers, shower panels, interior doors. In certain embodiments, light weight sheetings are formed with light-weight film materials at effective costs.

In certain embodiments, two films may be created where the first film has an image in a positive form and the second film has the identical image but in a negative form (i.e., inverted compared to the first film image). The two films may be pressed against each with the textured images of the films facing each other. Accordingly, the heights in the image of the first film will fit into the depths or valleys of the image of the second film and vice-a-versa, creating a suspended 3-D image positioned inside two outer flat, smooth surfaces. The benefit of this arrangement is to avoid crushing the 3-D images or filling the valleys of the images with glue or other adhesive substance when it is applied to glass or another surface. Optionally, the two images can be positioned face to face and flush to each other (both images in the same orientation), such that they do not fit with the grooves or valleys of the other. Optionally, this double film can be placed in between two pieces of glass or adhered to a single piece of glass. In another embodiment, a single film with a 3-D image can be used and a flat clear film may be placed over the textured image side to protect it and create a suspended 3-D image with two smooth surfaces.

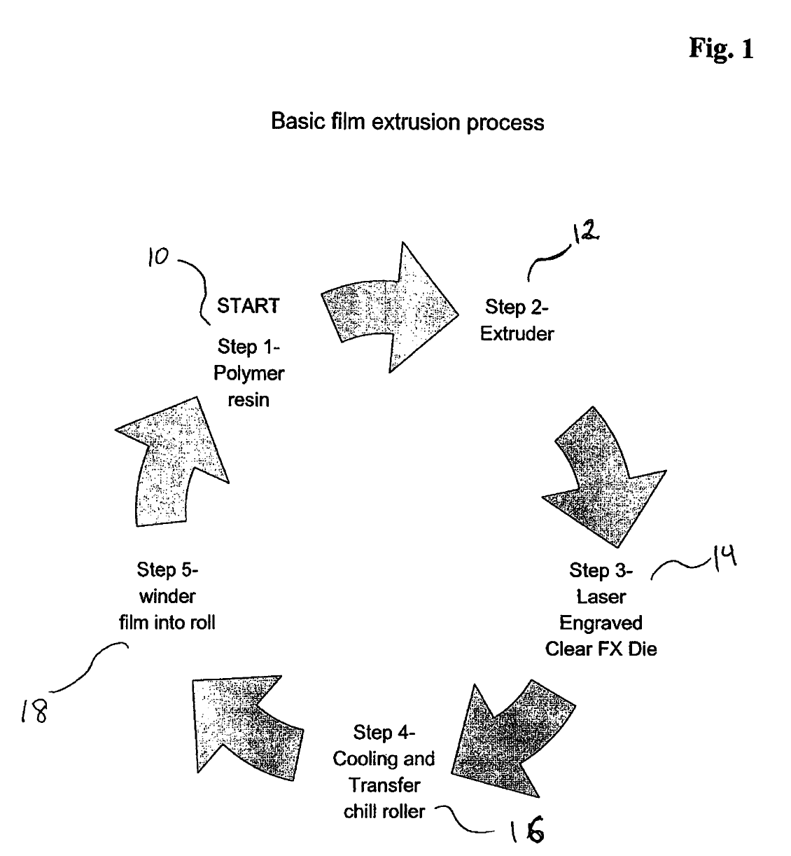

An example of a film extrusion process is shown in FIG. 1. A polymer resin film material is obtained 10. The polymer resin film material is added to an extruder 12. The polymer resin film material is extruded onto a laser engraved die created from a high resolution digital art file and relief file by any of the processes described above 14. As the polymer resin film material is extruded over the die, the image from the die is infused or transferred into the film and the film is cooled by transferring to a chill roll 16. Once the extruded film with 3-D designs, images, and/or text having depths or heights less than, equal to, and/or greater than half the thickness of the film is cooled, it is then wound into a roll 18. The cooled rolled film may optionally be outsourced to have adhesive or liners affixed to it and to be cut into sheets. In one embodiment, the film may be sent on rolls to be statically charged such that it can stick to non-porous surfaces through static electricity. It is then placed onto liners and cut into sheets. The rolls may be converted for a multitude of specific applications and uses.

As stated above, the foregoing is merely intended to illustrate various embodiments of the present invention. The specific modifications discussed above are not to be construed as limitations on the scope of the invention. It will be apparent to one skilled in the art that various equivalents, changes, and modifications may be made without departing from the scope of the invention, and it is understood that such equivalent embodiments are to be included herein. All references cited herein are incorporated by reference as if fully set forth herein.

What is claimed is:

1. A process for producing an art infused film comprising:
providing a high resolution art file having a design, wherein the design of the high resolution art file comprises a fill area having a series of lines, vector lines, dots, or marks;
converting the high resolution art file into a relief file having a design by assigning various depths or heights to the fill area;
engraving the design of the relief file into a die such that a design in the die mirrors the design of the relief file; and
extruding a material through the die to form a film, wherein the design from the die is infused into the film as the film is extruded, the image in the film having one or more paths with depths or heights.

2. The process of claim 1, wherein the design of the art file further comprises a border having a series of lines, vector lines, dots, or marks.

3. The process of claim 1, wherein the high resolution art file or the relief file has a resolution of 2000 dpi or higher.

4. The process of claim 1, wherein the high resolution art file or the relief file has a resolution of from 400 to 2000 dpi.

5. The process of claim 4, wherein the high resolution art file and the relief file have a resolution of from 1200 to 2000 dpi.

6. The process of claim 4, wherein the high resolution art file and the relief file have a resolution of from 1000 to 1200 dpi.

7. The process of claim 1, wherein the image in the film has one or more engraved paths with a maximum depth or height equal to or greater than half of the thickness of the film.

8. The process of claim 2, wherein the designed film has a thickness of from 0.003 inch to 0.25 inch.

9. The process of claim 8, wherein the ratio of the maximum depth or height of the one or more paths to the thickness of the film is at least about 0.03:1.

10. The process of claim 8, wherein the ratio of the maximum depth or height of the one or more paths to the thickness of the film is at least about 0.8:1.

11. The process of claim 8, wherein the ratio of the maximum depth or height of the one or more paths to the thickness of the film is at least about 0.1:1.

12. The process of claim 8, wherein the ratio of the maximum depth or height of the one or more paths to the thickness of the film is at least about 0.5:1.

13. The process of claim 1, wherein one or more design palettes are inserted into the high resolution art file or relief file to create a design with desired topography and/or visual effects.

14. The process of claim 1, wherein the film material is selected from the group consisting of Polycarbonate, Polypropylene, Polyethylene, PET-G; R-PET, A-PET, Co-Poly blends, Acrylic, and PVC.

15. The process of claim 14, wherein the ratio of the maximum depth or height of the one or more paths to the thickness of the film is at least about 0.03:1.

16. The process of claim 14, wherein the ratio of the maximum depth or height of the one or more paths to the thickness of the film is at least about 0.8:1.

17. The process of claim 14, wherein the ratio of the maximum depth or height of the one or more paths to the thickness of the film is at least about 0.1:1.

18. The process of claim 14, wherein the ratio of the maximum depth or height of the one or more paths to the thickness of the film is at least about 0.5:1.

19. The process of claim 14, wherein one or more design palettes are inserted into the high resolution art file or relief file to create a design with desired topography and/or visual effects.

20. The process of claim 1, wherein the film material is Polycarbonate.
